(19) United States
(12) Patent Application Publication
(10) Pub. No.: US 2008/0307787 A1
(43) Pub. Date: Dec. 18, 2008

(54) Power Generation System Using Fuel Cell

(76) Inventor: Jerry Pettersson, Uppsala (SE)

Correspondence Address: BIRCH STEWART KOLASCH & BIRCH, PO BOX 747, FALLS CHURCH, VA, 22040-0747, US

(21) Appl. No.: 11/792,697

(22) PCT Filed: Dec. 7, 2005
(86) PCT No.: PCT/SE05/01857

§ 371 Date: May 7, 2008

(30) Foreign Application Priority Data
Dec. 8, 2004 (SE) 0402990-6

(51) Int. Cl. F02G 3/00

(52) U.S. Cl. 60/624; 290/1 A

(57) ABSTRACT

The present invention relates to a power generating system, a motorised device comprising such a power generation system as well as a method of lowering the fuel consumption of a combustion engine (12). The power generation system comprises a combustion engine (12), an electrical power supply unit (18, 26) that is at least partly driven by exhaust fumes generated by said combustion engine and a reversely operated fuel cell (30) connected to the electrical power supply unit and the combustion engine. The reversely operated fuel cell is provided with electrical power by the electrical power supply unit and is arranged to emit hydrogen to the combustion engine for use in the operation thereof. In this way fuel consumption is lowered.

### TECHNICAL FIELD OF THE INVENTION

The present invention relates to the field of combustion engines and more particularly to a power generation system, a motorised device comprising such a power generation system as well as a method of lowering the fuel consumption of a combustion engine.

### DESCRIPTION OF RELATED ART

Within the field of motorised devices, like automotive vehicles, comprising combustion engines, there is a trend towards lowering the fuel consumption. A low fuel consumption is vital with regard to both fuel economy and lowering emission of exhaust fumes.

Because of the negative environmental effects caused by combustion engines, there are many countries and even states within countries that have set up emission limits for combustion engines. In order to meet these it is often necessary to enhance the efficiency of the combustion process in the engine.

There are a number of measures that historically have been provided for raising the efficiency of engines, like for instance providing a turbo charger that compresses air based on the exhaust air from an engine and feeds this compressed air to the engine.

One way of reducing fuel consumption is to provide an engine together with a fuel cell, which fuel cell generates electric power based on hydrogen and oxygen. For instance US2003/0168263 describes a fuel cell combustion engine combination, where the fuel cell receives fuel in the form of engine exhaust fumes and air. The fuel cell then generates electrical power that can be used for powering different parts of a vehicle in which the combination is provided. The fuel consumption will here be lowered because the battery of such a vehicle will supply less power to different functions and thus the generator for charging the battery will not have to recharge the battery as much.

It would however be of interest to provide an alternative way of reducing fuel consumption of a device while at the same time making the combustion engine more powerful.

### SUMMARY OF THE INVENTION

The present invention is directed towards solving the problem of providing an alternative way of reducing fuel consumption of a combustion engine for a motorised device while at the same time making the combustion engine more powerful.

One object of the present invention is directed towards providing a power generation system that reduces the fuel consumption of a combustion engine for a motorised device while at the same time making the combustion engine more powerful.

According to the present invention this object is achieved by a power generation system comprising:

a combustion engine,

an electrical power supply unit at least partly driven by exhaust fumes generated by said combustion engine, and

a reversely operated fuel cell connected to the electrical power supply unit and the combustion engine,

wherein said reversely operated fuel cell is provided with electrical power by said electrical power supply unit and is arranged to emit hydrogen to said combustion engine for use in the operation thereof.

This power generation system has the advantage of lowering the fuel consumption while at the same time making the engine more powerful. The invention can furthermore be applied on existing devices without any major changes of the power generation system already existing. This has the further advantage of allowing the generation of hydrogen, when the engine is running. There is thus no hazardous storing of hydrogen needed. The hydrogen is furthermore dependent on the engine performance. The more and harder the engine is working, the more hydrogen is generated. This also means that the invention can be implemented without special control mechanisms for controlling when and how much hydrogen is to be injected into the engine

One way of generating electrical power according to the present invention is to use a generator and a rotational element driven by exhaust fumes generated by the combustion engine for providing mechanical rotational energy to the generator for conversion to electrical power.

The rotational element is according to one embodiment provided in a turbo charging unit connected to the combustion engine. This has the advantage of combining the invention with pre-existing elements of an engine, which lowers the cost of the invention.

Additional mechanical rotational energy is in another variation of the invention provided to the generator via a shaft rotated by the combustion engine.

An additional of way of generating electrical power is by using a thermo electrical unit arranged to provide electrical power based on differences in temperature.

Electrical power can also be generated by the use of a battery or at least one solar cell.

According to another variation of the present invention the fuel cell is thermally connected to the combustion engine. In this way it is possible to enhance the efficiency of the fuel cell.

Another way of varying the present invention is through providing a hydrogen container between the fuel cell and the engine, which container can be controlled to supply hydrogen to said engine. In this way it is possible to provide a boosting effect for the engine.

A power supply unit can furthermore be arranged to supply the fuel cell with electrical power when a throttle is released simultaneously with a brake being activated by a user of the system, where both the throttle and the brake are associated with the engine. This feature allows the retaining of energy without major modifications of the device.

The fuel cell may receive fuel in the form of air and possibly water for generating hydrogen.

The hydrogen can be supplied to said combustion engine via at least one separate duct. This feature provides further safety in relation to the generated hydrogen.

The hydrogen can as an alternative be supplied to the combustion engine together with air through a standard air intake provided for said engine or together with compressed air from the turbo charging unit.

Another object of the present invention is directed towards providing a device having a power generation system that reduces the fuel consumption of a combustion engine while at the same time making the combustion engine more powerful.

This object is according to the present invention achieved by a motorised device comprising a power generation system comprising:

a combustion engine,

an electrical power supply unit at least partly driven by exhaust fumes generated by said combustion engine, and

a reversely operated fuel cell connected to the electrical power supply unit and the combustion engine,

wherein said reversely operated fuel cell is provided with electrical power by said electrical power supply unit and is arranged to emit hydrogen to said combustion engine for use in the operation thereof.

Yet another object of the present invention is to provide a method of lowering the fuel consumption of a combustion engine that reduces the fuel consumption of the combustion engine while at the same time making the combustion engine more powerful.

According to the present invention, this object is achieved by a method of lowering the fuel consumption of a combustion engine comprising the steps of:

generating electrical power at least partly based on exhaust fumes generated by said combustion engine

providing electrical power to a reversely operated fuel cell,

generating hydrogen in said fuel cell, and

injecting said hydrogen into the combustion engine.

### BRIEF DESCRIPTION OF THE DRAWINGS

The present invention will now be described in more detail in relation to the enclosed drawings, in which:

FIG. 1 schematically shows a device according to the present invention,

FIG. 2 schematically shows a power generation system according to a first embodiment of the present invention,

FIG. 3 schematically shows a preferred placing of a fuel cell in relation to a combustion engine according to a second embodiment of a power generation system according to the present invention,

FIG. 4 schematically shows a sectional view of a turbo charging unit used for generating electrical power for a fuel cell,

FIG. 5 shows a flow chart of a method of lowering fuel consumption according to the present invention,

FIG. 6 schematically shows a first variation of an electrical power supply unit supplying power to a fuel cell,

FIG. 7 schematically shows a second variation of an electrical power supply unit supplying electrical power to a fuel cell,

FIG. 8 schematically shows a third variation of an electrical power supply unit supplying electrical power to a fuel cell, and

FIG. 9 schematically shows the fuel cell of FIG. 3 where a hydrogen container is connected between the fuel cell and the engine.

### DETAILED DESCRIPTION OF EMBODIMENTS

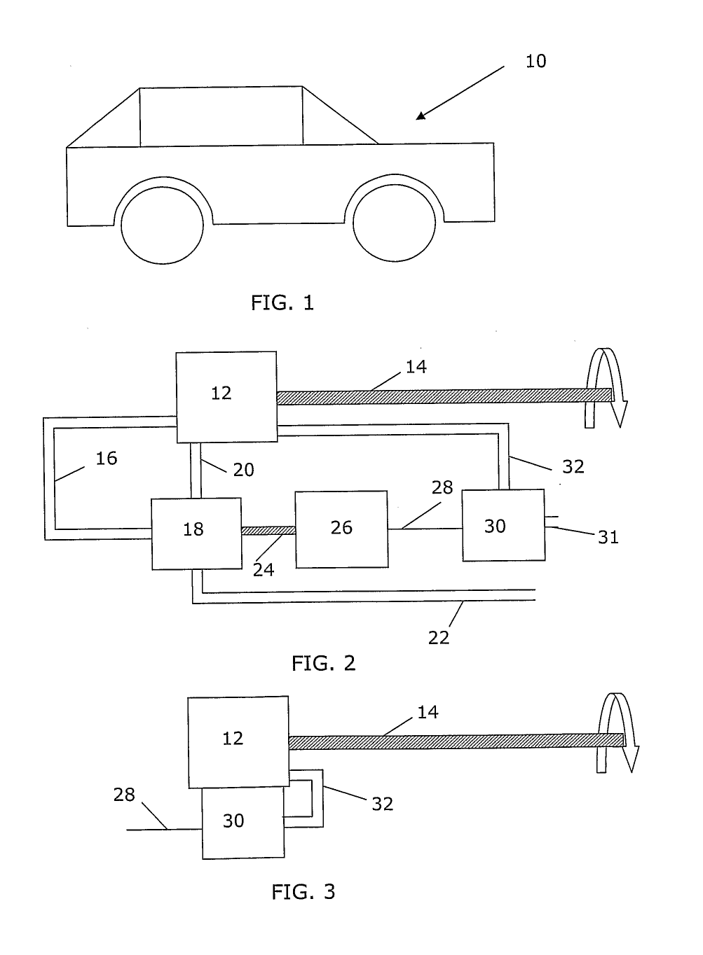

The present invention is related to lowering the fuel consumption of different type of motorised devices. FIG. 1 schematically shows one such device, where the device is a vehicle in the form of an automobile 10. It should be realised that the invention is just as well applicable to other types of vehicles such as buses, trucks, motorcycles etc. as well as other types of devices like aeroplanes, ships and even lawn mowers or chain saws. What is important though is that the device is using a combustion engine.

FIG. 2 schematically shows a power generation system provided in the automobile shown in FIG. 1. The power generation system includes an internal combustion engine 12 running on some kind of fluid, like for instance gasoline or diesel, and a first shaft 14 being rotated by the engine 12. As is well known there are exhaust fumes generated in the combustion process of the engine 12. These exhaust fumes leave the engine 12 via a first duct 16 leading to a turbo charging unit 18. This turbo charging unit 18 provides compressed air to the engine 12 via a second duct 20 and also drives a second shaft 24. The driving of the second shaft 24 and the compressed air are provided through the use of the exhaust fumes, which fumes leave the turbo charging unit 18 via a third duct 22. The second shaft 24 provides mechanical rotational energy to a generator 26 that converts the rotational energy to electrical power, which power is supplied to a fuel cell 30. Such generators are well known within the field and will not be further described in detail here. At least a part of the turbo charging unit 18 and the generator 26 make up a first example of an electrical power supply unit according to the present invention. The fuel cell has an input 31 for receiving fuel in the form of water and/or air. The fuel cell 30 is reversely operated and generates hydrogen possibly together with oxygen. The hydrogen is supplied to the engine 12 via a fourth duct 32. The fourth duct 32 is separate from the other ducts leading to the engine in order not to mix the hydrogen with air before entering the engine 12. It should here be noted that the present invention need not be using the whole of the turbo charging unit 18, but can be limited to the use of only a turbine wheel therein for generating electrical power.

There are a number of different types of fuel cells that can be used according to the invention. According to a first embodiment of the present invention, the fuel cell is a Proton Exchange Membrane Fuel Cell (PEMFC) that uses water as fuel.

However there are also other fuel cell types that can be used. A second and preferred type of fuel cell is the Solid Oxide Fuel Cell (SOFC). One such cell is schematically shown in FIG. 3. This fuel cell 30 is also operated in dependence of heat in addition to electrical power. It thus operates more efficiently when it is warm. Therefore there is a thermal connection between the fuel cell 30 and the engine 12, which in the figure is indicated by the fuel cell being placed directly in contact with the engine 12. This fuel cell can furthermore be using air as fuel. Although the exact configuration is not shown in FIG. 3, the fuel cell here is also supplied with electrical power by the turbo charging unit and a generator of FIG. 2 in order to supply hydrogen to the engine 12. A second and presently preferred embodiment and contemplated best mode of the present invention uses the fuel cell of FIG. 3 thermally connected to the engine and being provided with electrical power in the way outlined in FIG. 2. Of course this fuel cell can be provided without this thermal connection, but then the performance will not be as good as it can be.

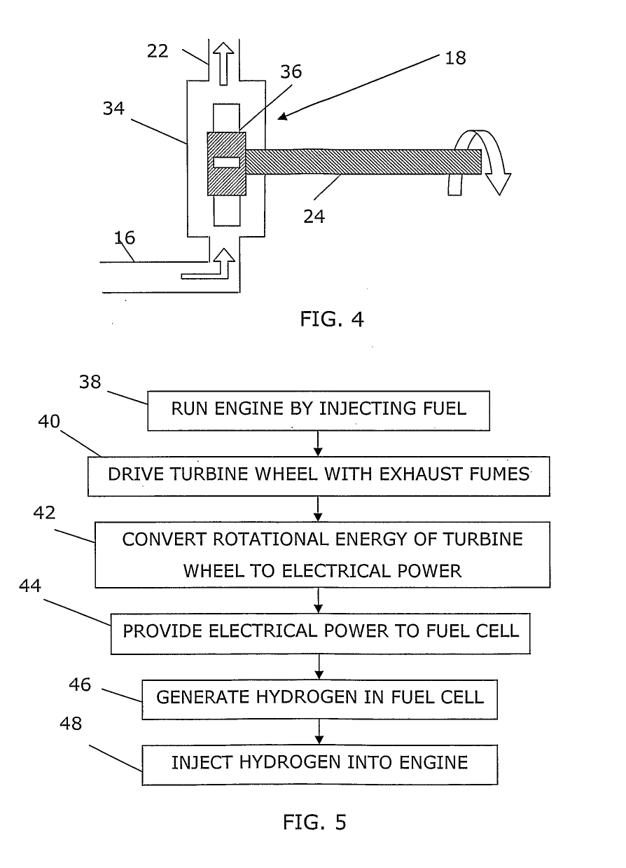

The way electrical power is generated according to the system shown in FIG. 2, will now be further described in relation top FIG. 4, which shows a sectional view of the parts of the turbo charging unit that are relevant for the present invention. Exhaust fumes, emitted by the engine, leave the engine via the first duct 16 and enters a chamber 34 of the turbo charging unit. In the chamber 34 there is provided a rotational element in the form of a turbine wheel 36, which gets turned by the exhaust fumes entering the chamber 34. The exhaust fumes thereafter leave the chamber 34 via duct 22. The turbine wheel 36 rotates the second shaft 24, where the mechanical rotational energy is transferred to the generator for conversion to electrical power. The turbo charging unit can as mentioned before include a compressor, which is also driven by the turbine wheel for compressing air injected into the engine. As mentioned before the present invention is not dependent on this compressing of air or of the turbo charging unit at all. In fact only the parts shown in FIG. 4 might be provided as a part of a power supply unit used for enabling provision of electrical power for the fuel cell. There are other ways of providing electrical power to the fuel cell in addition to using the turbine wheel, which will be described in more detail later.

The method the power generation system of the present invention works according to can thus be summarised in the following way, with reference being made to FIG. 5, which shows a flow chart of a method according to the present invention. The engine is first run through injecting fuel into it, like for instance gasoline or diesel, step 38. The running engine thereafter generates exhaust fumes because of the combustion process, where these exhaust fumes are used for driving the turbine wheel of the turbo charging unit, step 40. The rotational energy provided by this wheel is then supplied to the generator via the second shaft, which generator converts the rotational energy to electrical power, step 42. The electrical power is then provided to the fuel cell for operating it reversely, step 44. There the fuel cell generates hydrogen, step 46, which is injected into the engine, step 48.

The method described above has a number of advantages. By injecting hydrogen the fuel consumption is lowered. Hydrogen is furthermore generated on the spot, when the engine is running. There is thus no hazardous storing of hydrogen. The hydrogen is furthermore dependent on the engine performance. The more and harder the engine is working and the hotter it gets, all depending on the rotational speed of the first shaft, the more hydrogen is generated. It is thus possible to significantly reduce fuel consumption of the engine. By using the turbine wheel solution for generating electrical power, already existing elements in an automobile are put to additional use, which lowers the cost of the power generation system. The invention can furthermore be provided with just small modifications of already existing power generation systems.

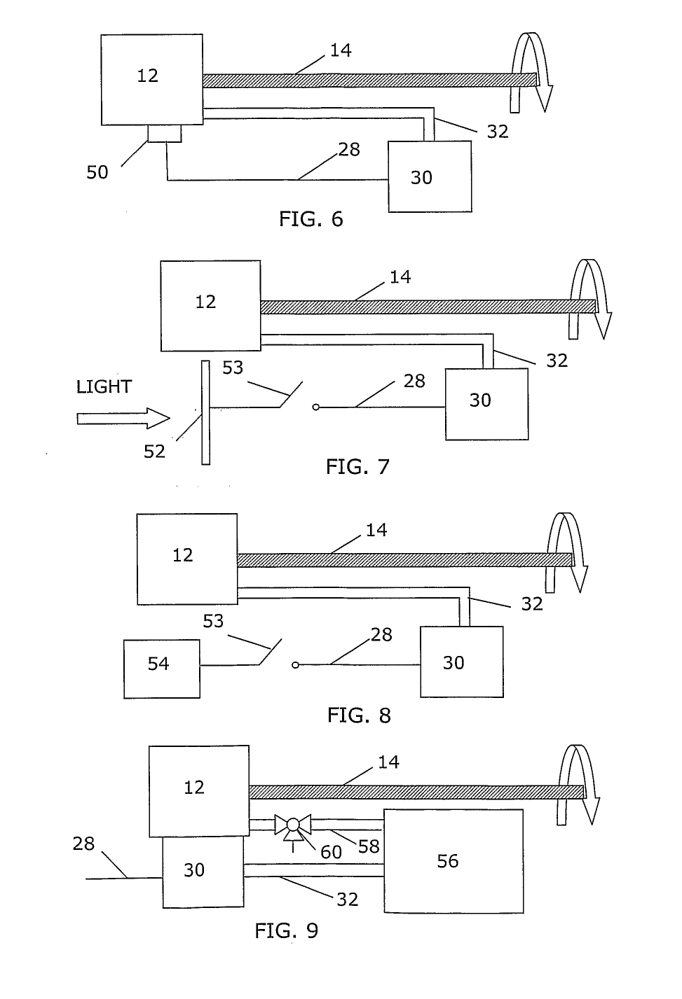

As mentioned before it is possible to provide additional electrical power for the fuel cell. It is for instance possible to also get rotational energy to the generator directly from the first shaft rotated by the engine. Another additional electrical power source that is also dependent on the performance of the engine is schematically shown in FIG. 6, where a thermo electrical unit 50 is provided on the engine 12 and generating electrical power based on temperature. This can be a thermo electrical unit in the form of a so called Peltier element that generates electrical power based on temperature differences. This difference can be the difference between the engine temperature and outside air. In cold weather it can also be the temperature difference between the engine and snow. The advantage of generating electrical power for a fuel cell based on the running of the engine is that the fuel cell will be generating hydrogen automatically when needed in a simple way without having to control the process through a separate control mechanism.

There are furthermore other ways generating additional power for the fuel cell that are not depending on the engine performance, where another variation is shown in FIG. 7. Here the electrical power supply unit is provided as a solar panel 52 comprising one or more solar cells, which can be provided on the outside of the car in FIG. 1. This solar panel 52 here receives solar light and converts the solar energy therein to electrical power for the fuel cell. Another variation is shown in FIG. 8, where the electrical power supply unit is a battery 54, which can be the standard automobile battery or another separate battery which is used for powering the fuel cell. In this case it possible that the battery has to be loaded when the car is not in use. Such loading can for instance be done by using a solar panel. In order not to provide electrical power unless the engine is run, there is provided a switch 53 in the electrical connection 28 between the electrical power supply unit and the fuel cell in FIGS. 7 and 8. The switch 53 can then be closed when the car is started or when the engine rotates the first shaft with a certain rotational speed. If a variation of the generated hydrogen is needed it is then possible to provide a separate control mechanism by providing a suitable logical circuit that receives information about for instance the rotational speed of the first shaft and varies the supplied electrical power accordingly.

Another possible way of providing additional electrical power is by using wind power converting elements.

Yet another possible variation of the present invention is that the hydrogen is not used immediately. This can be the case in race car applications. A variation of this case is shown in FIG. 8, where the fuel cell 30 of FIG. 3 is used. Here the fourth duct 32 leads to a hydrogen container 56, which is connected to the engine 12 via a fifth duct 58. This container 56 can then be filled during driving, and the contents injected into the engine at a special point in time selected by the driver, for instance when he needs extra power in order to overtake another car. For this reason there is provided a valve 60 in the fifth duct 58, which valve 60 can be opened by mechanical or electrical actuation when the driver of the car pushes a switch. In this way the driver can control the supply of hydrogen to the engine.

The device in FIG. 8 can be modified further in that if the driver releases the throttle and activates the brakes so that the car decelerates, the standard generator of the car is connected to the shaft 14 and can be made to supply electrical power to the fuel cell 30. Hydrogen is then stored in the container 56 and can be used once the car accelerates. As an alternative the generator used in this way can be separate from the standard generator of the car and be connected to the first shaft linearly with the braking. There can furthermore be other ways in which electrical power is supplied to the fuel cell during braking, like through one of the above described ways depending on solar power, wind power or battery.

There are many other variations that can be made to the present invention apart from the ones described above. Above the hydrogen was supplied to the engine via a separate duct. It is also possible to provide the hydrogen to the engine together with compressed air from the turbo charging unit or together with air supplied to the engine via a standard air intake of said engine.

Although the present invention has been described in connection with specific embodiments, it is not intended to be limited to the specific form set forth herein. Rather, the scope of the present invention is limited only by the accompanying claims. In the claims, the term comprising does not exclude the presence of other elements or steps.

Additionally although individual features may be included in different claims, these may possibly be advantageously combined and the inclusion in different claims does not imply that a combination of features is not feasible and/or advantageous. In addition singular references do not exclude a plurality. Thus references to “a”, “an”, “first”, “second” etc. do not preclude a plurality. Reference signs in the claims are provided merely as a clarifying example and shall not be construed as limiting the scope of the claims in any way.

1. Power generation system comprising: a combustion engine (12), an electrical power supply unit (36, 24, 26; 50; 52; 54) at least partly driver by exhaust fumes generated by said combustion engine, and a reversely operated fuel cell (30) connected to the electrical power supply u and the combustion engine, wherein said reversely operated fuel cell is provided with electrical power by said electrical power supply unit and is arranged to emit hydrogen to said combustion engine for use in the operation thereof.

2. Power generation system according to claim 2, wherein said electrical power supply unit comprises a generator (26) and further comprising a rotational element (36) driven by said exhaust fumes for providing mechanical rotation energy to said generator for conversion to electrical power.

3. Power generation system according to claim 2, wherein said rotational element is provided in a turbo charging unit (18) connected to said combustion engine

4. Power generation system according to claim 3, wherein the hydrogen is provided to said engine together with compressed air from said turbo charger unit.

5. Power generation system according to claim 2, wherein said generator furthermore receives mechanical rotational energy via a shaft (14) rotated b) said combustion engine.

6. Power generation system according to any previous claim, wherein said power supply unit comprises a thermo electrical unit (50) arranged to provide electrical power based on differences in temperature.

7. Power generation system according to claim 1, wherein said power supply unit comprises a battery (54).

8. Power generation system according to claim 1, wherein said power supply unit comprises at least one solar cell (52).

9. Power generation system according to claim 1, wherein said fuel cell is thermally connected to said combustion engine.

10. Power generation system according to claim 1, further comprising a hydrogen container (56) connected between the fuel cell and the engine, which container can be controlled to supply hydrogen to said engine.

11. Power generation system according to claim 10, wherein a power supply unit is arranged to supply said fuel cell with electrical power when a throttle is released simultaneously with a brake being activated by a user of the system, where both said throttle and said brake are associated with said engine.

12. Power generation system according to claim 1, wherein the fuel cell receives fuel in the form of air and possibly water for generating hydrogen.

13. Power generation system according to claim 1, wherein the hydrogen is supplied to said combustion engine via at least one separate duct (32; 32, 58).

14. Power generation system according to claim 1, wherein the hydrogen is supplied to said combustion engine together with air through a standard air intake provided for said engine.

15. Power generation system according to claim 1, wherein the combustion engine is operable through fuel being injected into it.

16. Motorised device (10) comprising a power generation system comprising: a combustion engine (12), an electrical power supply unit (36, 24, 26; 50; 52; 54) at least partly driven by exhaust fumes generated by said combustion engine, and a reversely operated fuel cell (30) connected to the electrical power supply unit and the combustion engine, wherein said reversely operated fuel cell is provided with electrical power by said electrical power supply unit and is arranged to emit hydrogen to said combustion engine for use in the operation thereof.

17. Motorised device according to claim 16, wherein the combustion engine is operable through fuel being injected into it.

18. Method of lowering the fuel consumption of a combustion engine (12) comprising the steps of: generating electrical power at least partly based on exhaust fumes generated by said combustion engine, (steps 40, 42) providing electrical power to a reversely operated fuel cell (30), (step 44), generating hydrogen in said fuel cell, (step 46), and injecting said hydrogen into the combustion engine, (step 48).

19. Method according to claim 18, further comprising the steps of injecting fuel into the combustion engine for running said combustion engine (step 38).

20. Method according to claim 18 or 19, wherein the step of generating electrical power comprises driving a rotational element with exhaust fumes from said engine, (step 40), and converting the rotational energy of the turbine wheel to electrical power, (step 42)
